(19) United States
(12) Patent Application Publication
(10) Pub. No.: US 2025/0230285 A1
(43) Pub. Date: Jul. 17, 2025

(54) MECHANICALLY ROBUST MULTIMATERIAL FOR ADDITIVE MANUFACTURING

(71) Applicant: Lawrence Livermore National Security, LLC, Livermore, CA (US)

(72) Inventors: Eric Jonathan Constant, Foster, WV (US); Sijia Huang, Dublin, CA (US)

(21) Appl. No.: 18/410,885

(22) Filed: Jan. 11, 2024

(51) Int. Cl. C08G 75/045

(52) U.S. Cl. CPC C08G 75/045

(57) ABSTRACT

A precursor resin mixture for forming a multimaterial includes a multifunctional monomer comprising two or more first functional groups bonded to a base molecule and two or more terminal functional groups having a double-bonded carbon, a multifunctional thiol monomer having one or more second functional groups positioned between terminal thiol groups, and epoxy monomer, and a curing agent. Regarding the multifunctional monomer, the terminal functional groups being different than the first functional groups.

This invention was made with Government support under Contract No. DE-AC52-07NA27344 awarded by the United States Department of Energy. The Government has certain rights in the invention.

### FIELD OF THE INVENTION

The present invention relates polyurethane material, and more particularly, this invention relates to mechanically robust multimaterial for additive manufacturing.

### BACKGROUND

One of the challenges in photopolymerization is although the additive manufacturing process enables the creation of intricate three-dimensional shapes with tailored geometries, the materials available for the process exhibit low toughness. Despite ongoing efforts in materials development, material choices remain limited. Furthermore, recycling of multimaterials, particularly crosslinked networks, remains impractical and low in value due to numerous complexities associated with reprocessing and repurposing these materials.

Early simple multimaterial processes included resin vat exchange for a multi-layered design where each layer was formed with a different resin providing a specific mechanical toughness. The disadvantages of the resin vat exchange included limited material stock, cross-contamination between the layers, and only layer to layer change in material mechanical properties. More established multimaterial photochemistries encompass blue light-initiated cationic polymerization of epoxy combined with UV-initiated free radical polymerization of acrylate, resulting in distinct soft and stiff regions within one layer. The disadvantages of these processes include the need for a very sophisticated multiwavelength printer.

A recent breakthrough showcased a novel dual-stage curing hybrid ink, merging acrylate homopolymerization with aza-Michael reaction to achieve single-vat grayscale DLP 4D printing. The multimaterial process involves blue light-initiated anionic thiol-Michael addition with UV-initiated radical polymerization of acrylate. However, a persistent challenge remains: the “soft” regions within these objects retain unreacted groups that continue polymerizing and solidifying upon exposure to ambient light or heat until complete conversion of the reactive moieties occurs. The material formed from this process is extremely brittle. In addition, the material is volatile during thermal curing, and unreacted monomers remain in the material. Implementing these chemistries in 3D printing necessitates special considerations, such as customized printers with multiple light sources or the inclusion of photochromic species to enhance subtle absorption differences between photoinitiators with broad overlapping spectra.

In these conventional polymer systems, a single resin generates a single material; however, a single resin does not produce a multiple material. Conventional processes for forming a multimaterial system using photopolymerization processes, drawbacks of these systems include the complete curing of the material and the material has very low modulus and very low toughness. For example, the multimaterial is brittle, and the toughness is very low compared to what you need in the engineering system. Moreover, none of these system are able to recycle the polymer. Once the multimaterial is made, the multimaterial remains in the environment forever.

There remains a need to overcome the challenges of photopolymerization processes to fabricate parts without undesirable soft regions.

### SUMMARY

According to one embodiment, a precursor resin mixture for forming a multimaterial includes a multifunctional monomer comprising two or more first functional groups bonded to a base molecule and two or more terminal functional groups having a double-bonded carbon, a multifunctional thiol monomer having one or more second functional groups positioned between terminal thiol groups, and epoxy monomer, and a curing agent. Regarding the multifunctional monomer, the terminal functional groups being different than the first functional groups.

According to another embodiment, a method of forming a multimaterial includes subjecting a precursor resin mixture to a first polymerization and/or crosslinking stimulus for forming an intermediate resin mixture. The precursor resin mixture includes a multifunctional monomer having two or more first functional groups bonded to a base molecule, and two or more terminal functional groups having a double-bonded carbon, the terminal functional groups being different than the first functional groups. The precursor resin mixture also includes a multifunctional thiol monomer having two or more second functional groups positioned between terminal thiol groups, an epoxy monomer, and a curing agent. The intermediate resin mixture includes partially crosslinked polymers comprising the multifunctional monomer and the multifunctional thiol monomer. In addition, the method includes subjecting the intermediate resin mixture to a second polymerization and/or crosslinking stimulus for curing to a predefined extent thereby forming a multimaterial characterized as a polymeric material. The multimaterial has a plurality of predefined portions, each predefined portion having a predefined mechanical strength that is different than at least one other predefined portion.

According to yet another embodiment, a multimaterial includes a polymeric material comprising urethane linkages. The multimaterial is comprised of predefined portions, a first of the predefined portions having a first mechanical toughness and a second of the predefined portions having a second mechanical toughness different than the first mechanical toughness. The polymeric material is configured to be converted into monomer by-products.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1A is a schematic diagram of a previous approach for forming a multimaterial.

FIG. 1B is a schematic diagram of components of a resin for forming a multimaterial in a previous approach.

FIG. 2A is a schematic diagram of components of a precursor resin mixture, according to one embodiment.

FIG. 2B depicts functional groups for a multifunctional monomer, according to one embodiment.

FIG. 3 is a flow chart of a method, according to one embodiment.

FIG. 4 is a schematic diagram of components of a resin for forming a urethane multimaterial that is recyclable, according to one embodiment.

FIG. 5 is a schematic diagram of increasing allyl functional groups on an alkene monomer for a resin, according to one embodiment.

FIG. 6 is a schematic diagram of a multimaterial, according to one embodiment. Part (a) is a multimaterial having portions of two different mechanical toughness, part (b) is a multimaterial having portions of three different mechanical toughness.

FIG. 7 is a schematic drawing of the depolymerization of the polymeric material, according to one embodiment. Part (a) is a schematic drawing of the reaction pathways, part (b) are images of the polymeric material before and after depolymerization, and part (c) are schematic diagrams of the polymeric network before and after depolymerization.

FIG. 8 is a series of plots of the mechanical properties of a multimaterial formed with a resin that includes 3-arm triallyl alkene monomer, according to one embodiment. Part (a) is a plot of stress vs. strain of the multimaterial having varying curation times, part (b) is a plot of the Young's modulus of the multimaterial, part (c) is a plot of the strain at break of the multimaterial, part (d) is the toughness of the multimaterial, and part (e) is the UTS of the multimaterial.

FIG. 9 is a series of plots of the mechanical properties of a multimaterial formed with a resin that includes 9-allyl alkene monomer, according to one embodiment. Part (a) is a plot of stress vs. strain of the multimaterial having varying curation times, part (b) is a plot of the Young's modulus of the multimaterial, part (c) is a plot of the strain at break of the multimaterial, part (d) is the toughness of the multimaterial, and part (e) is the UTS of the multimaterial.

FIG. 10 is a series of plots of the modulus of a multimaterial over time, according to one embodiment. Part (a) depicts a multimaterial formed with a 3-arm triallyl alkene monomer, and part (b) depicts a multimaterial formed with a 9-allyl alkene monomer.

FIG. 11 is a plot of the toughness versus elastic modulus of multimaterials formed according to various approaches, according to one embodiment.

FIG. 12A is a plot of the stress versus strain of a multimaterial having tensile gradient, according to one embodiment.

FIG. 12B is a schematic drawing of dog-bone structures having regions of varying mechanical properties, according to one embodiment.

FIG. 13 is a series of images of a multimaterial dog-bone structure, according to one embodiment. Part (a) is an image of two regions of 0 seconds and 200 seconds of the dog-bone, and part (b) is a magnified view of a portion of the image of part (a).

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A “nano” dimension or descriptor such as nanoscale, nanoporous, etc. is defined as having a diameter or length (e.g., a pore having an average diameter) less than 1000 nanometers (nm). A “micro” dimension or descriptor such as microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred embodiments of mechanically robust multimaterial for additive manufacturing and/or related systems and methods.

In one general embodiment, a precursor resin mixture for forming a multimaterial includes a multifunctional monomer comprising two or more first functional groups bonded to a base molecule and two or more terminal functional groups having a double-bonded carbon, a multifunctional thiol monomer having one or more second functional groups positioned between terminal thiol groups, and epoxy monomer, and a curing agent. Regarding the multifunctional monomer, the terminal functional groups being different than the first functional groups.

In another general embodiment, a method of forming a multimaterial includes subjecting a precursor resin mixture to a first polymerization and/or crosslinking stimulus for forming an intermediate resin mixture. The precursor resin mixture includes a multifunctional monomer having two or more first functional groups bonded to a base molecule, and two or more terminal functional groups having a double-bonded carbon, the terminal functional groups being different than the first functional groups. The precursor resin mixture also includes a multifunctional thiol monomer having two or more second functional groups positioned between terminal thiol groups, an epoxy monomer, and a curing agent. The intermediate resin mixture includes partially crosslinked polymers comprising the multifunctional monomer and the multifunctional thiol monomer. In addition, the method includes subjecting the intermediate resin mixture to a second polymerization and/or crosslinking stimulus for curing to a predefined extent thereby forming a multimaterial characterized as a polymeric material. The multimaterial has a plurality of predefined portions, each predefined portion having a predefined mechanical strength that is different than at least one other predefined portion.

In yet another general embodiment, a multimaterial includes a polymeric material comprising urethane linkages. The multimaterial is comprised of predefined portions, a first of the predefined portions having a first mechanical toughness and a second of the predefined portions having a second mechanical toughness different than the first mechanical toughness. The polymeric material is configured to be converted into monomer by-products.

A list of acronyms used in the description is provided below.

| | |
|---|---|
| 3D | three-dimensional |
| AM | additive manufacturing |
| BisDE | bisphenol A diglycidyl ether |
| C | Celsius |
| IPDI | Isophorone diisocyanate |
| PETMP | pentaerythritol tetra(3-mercaptopropionate) |
| PU | polyurethane |
| TATATO | triallyl-1,3,5-triazine-2,4,6-trione |
| wt. % | weight percent |

In today's rapidly expanding library of photopolymer materials, the ability to tune material properties is crucial when selecting the appropriate material for a given application. The introduction of multimaterial systems has enabled the production of objects with varying mechanical properties within a single component, a feat that is often unattainable with traditional manufacturing methods. Seamless multimaterial construction, particularly joining soft tissues with stiff structures, is a common motif in animal physiology. A multimaterial is polymeric material having a modulus gradient. A single part has predefined moduli gradients that may include a rigid material and a soft material, with each material formed from a single precursor resin. However, common fabrication methods struggle to readily produce smooth mechanical transitions between mechanically disparate materials.

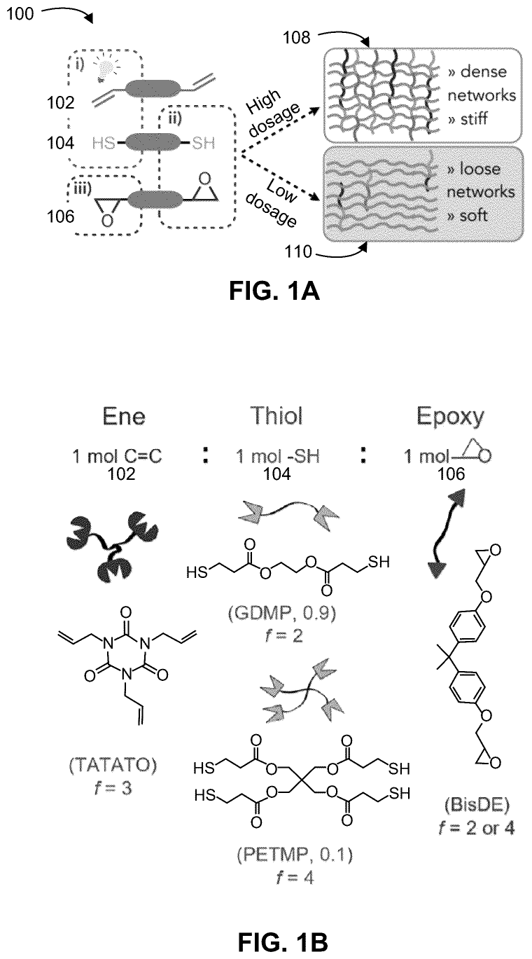

An early approach of a chemical process of using a single resin to form a multimaterial included the process depicted in FIG. 1A. For instance, a resin 100 includes three components, an ene 102, a thiol 104, and an epoxy 106. Exposing the resin to high dosage light forms dense networks and stiff regions 108, and exposing the resin to low dosage forms loose networks and soft regions 110. Examples of each components are depicted in FIG. 1B, where an ene component 102 may be a TATATO molecule, a thiol component 104 may be a PETMP molecule, and an epoxy component may be a BisDE molecule.

However, drawbacks of this early system included low toughness of the resulting material. Without wishing to be bound by any theory, it is believed that the absence of a chemical backbone for each of these components may contribute to the lack of mechanical toughness of the formed multimaterial.

This previous work explored the utility of thiol-ene, thiol-epoxy, and epoxy-epoxy reactions in producing multimaterial systems. However, there has been no suggestion to explore the incorporation of a urethane backbone into the multimaterial system. The urethane backbone included in one of the components also allows the formed structure to be recycled. Accordingly, in one embodiment, a novel material composition is described for the development of chemically recyclable and mechanically robust multimaterials suited for additive manufacturing applications.

According to one embodiment, a ternary reaction scheme produces photostable multimaterials with robust moduli gradients by controlling the photoconversion during processing. The resultant intricate multimaterial architectures exhibit properties that span the regimes of rigid plastics down to biological soft tissues. A novel homogeneous single-pot multimaterial system based on thiol-ene, thiol-epoxy, and epoxy-epoxy reactions is explored here as a new multimaterial chemistry platform. The development of this photopolymer-based multimaterial system represents a significant advancement in AM and expands the possibilities within the photopolymer material library.

According to one embodiment, a single resin forms a multimaterial such that the resin is tuned to produce a material having regions of different mechanical properties. A multimaterial is a single material having predefined regions having specific mechanical properties, e.g., stiff, soft, etc. For example, the material has regions of variable mechanical stiffness, and the locations of these regions are predefined. According to various embodiments, an ability to tune mechanical properties within a single component opens up new avenues for creating functional objects with tailored characteristics, particularly in biomedical application where complex modulus gradients are desired.

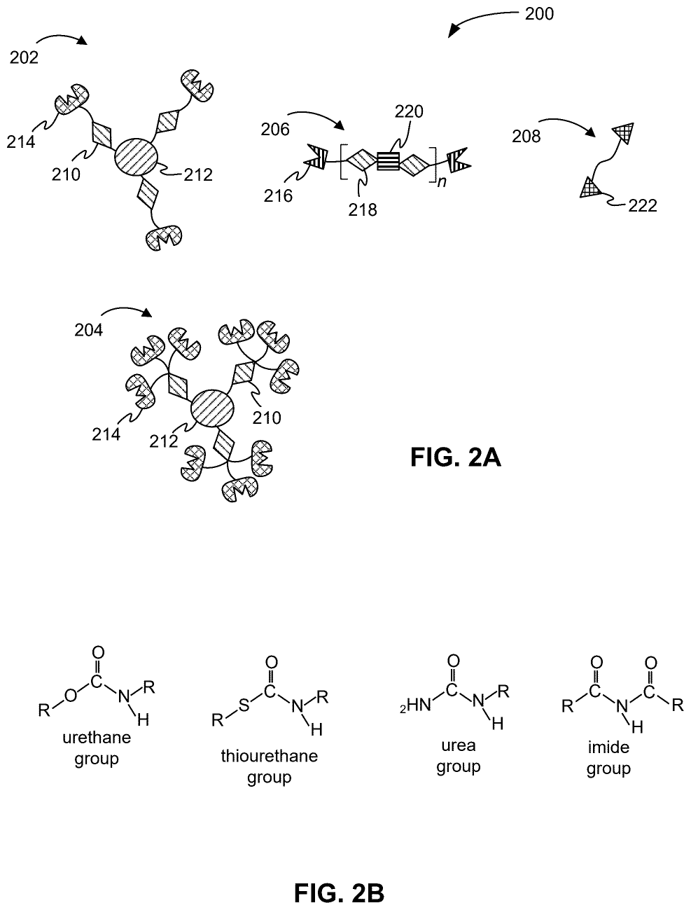

An innovative and uniform single-pot functional backbone-based multimaterial system, based on a combination of thiol-ene, thiol-epoxy, and epoxy-epoxy reactions, is disclosed herein. FIG. 2A depicts a precursor resin for forming a multimaterial, in accordance with one embodiment. As an option, the present precursor resin 200 may be implemented in conjunction with features from any other embodiment listed herein, such as those described with reference to the other FIGS. Of course, however, such precursor resin 200 and others presented herein may be used in various applications and/or in permutations which may or may not be specifically described in the illustrative embodiments listed herein. Further, the embodiments presented herein may be used in any desired environment.

According to one embodiment, a resin includes an ene component, a thiol component, and an epoxy component, where at least one of the components includes a functional backbone. The term “ene” represents a double-bonded carbon in the component, preferably in a terminal functional group of the component. As illustrated in FIG. 2A, a precursor resin mixture 200 for forming a multimaterial includes a multifunctional monomer 202, a multifunctional thiol monomer 206, and an epoxy monomer 208.

The multifunctional monomer 202 may represent an ene component having two or more terminal functional groups 214 having a double-bonded carbon. The multifunctional monomer 202 includes two or more functional groups 210 bonded to a base molecule 212. In some approaches, the base molecule 212 combined with the functional groups 210 functions as a backbone of the multifunctional monomer 202. In some approaches, the two or more functional groups 210 bonded to a base molecule 212 form a backbone of the multifunctional monomer 202. The terminal functional groups 214 are preferably different than the other functional groups 210 of the multifunctional monomer 202.

In various approaches, the base molecule of the multifunctional monomer may include a triazine trione molecule, an aliphatic molecule, a triphenol molecule, etc. In some approaches, the functional groups 210 form a backbone of the multifunctional monomer 202. FIG. 2B illustrates various groups that may be included as a functional group 210 on the multifunctional monomer. Each of these functional groups participate in crosslinking and provide a backbone to the monomer. These functional groups 210 are illustrated as arms of the monomer 202, where each arm includes a terminal functional group 214 having a double-bonded carbon. In various approaches, the functional backbone may include one of the following: a urethane group, a thiourethane group, a urea group, an imide group, etc. In one exemplary approach, the functional group may include a urethane group. The functional groups illustrated in FIG. 2B provide hydrogen bonding in the backbone of the monomer for forming the multimaterial.

According to one approach, a urethane multimaterial system includes a precursor resin including three different monomers: one multifunctional “ene” monomer having and a plurality of urethane groups at least one terminal double-bonded carbon associated with each urethane group, one monomer having at least one thiol group, and a monomer having at least one epoxy group. In one approach, a multifunctional monomer includes at least one urethane functional group for forming a polyurethane backbone in the multimaterial. In a preferred approach, a multifunctional monomer includes at least three urethane functional groups. Preferably, each urethane functional group is bonded to the base molecule of the multifunctional monomer.

In another approach, an ene multifunctional monomer includes at least one urea functional group for forming a polyurea backbone in the multimaterial. In yet another approach, an ene multifunctional monomer includes at least one imide functional group for forming a polyimide backbone in the multimaterial.

In some approaches, the ene multifunctional monomer includes at least three terminal functional groups having a double-bonded carbon. In one approach, the ene multifunctional monomer includes at least six terminal functional groups having a double-bonded carbon. For example, as illustrated in FIG. 2A, an ene multifunctional monomer 204 may include three terminal functional groups 214 having a double-bonded carbon associated with each arm having a functional group 210, such that the ene multifunctional monomer 204 has nine terminal functional groups 214 having a double-bonded carbon. Preferably, the multifunctional monomer includes a plurality terminal functional groups that are amenable to crosslinking. In various approaches, terminal functional groups of a multifunctional monomer may include at least one of the following: allyl, allyl ether, vinyl ether, acrylate, methacrylate, propene, norbornene, acrylonitrile, butadiene, methyl crotonate, fumarate, styrene, and maleimide. In one exemplary approach, each ene multifunctional monomer may include one or more terminal allyl groups.

In one approach, a multifunctional monomer is a diallyl ene monomer having two functional urethane groups and each urethane arm having a terminal allyl group. Without wishing to be bound by any theory, a diallyl ene monomer is beneficial for degradation of the multimaterial for recycling the components.

In some approaches, a multifunctional monomer may include more than two terminal functional groups. In one approach, a multifunctional monomer having greater than three terminal functional groups may reduce gelation point of the resin. More functional groups on the ene multifunctional monomer may further shorten the gelation time (e.g., the time to crossover of storage modulus and loss modulus). A shortened gelation time allows printing of a more complex structure using the resin in additive manufacturing techniques.

Moreover, increasing the multifunctional groups of an ene monomer allows a greater diversity in mechanical properties of portions of the multimaterial according to the dosage of light-intensity during light-induced polymerization.

As illustrated in FIG. 2A, a thiol multifunctional monomer 206 of the precursor resin 200 may include additional functional groups 218, 220 that function as a backbone for the thiol monomer 206 between terminal thiol groups 216. In some approaches, a base molecule 220 may be a functional group, for example, an isophorone diisocyanate (IPDI), aliphatic, toluene, diphenylmethane, methylenebus (cyclohexyl), phenyl molecule. A thiol multifunctional monomer 206 may include functional groups 218 that provide hydrogen bonding and a high reactivity toward the polymerization reaction between the monomers. For example, a thiol multifunctional monomer may include functional groups, as illustrated in FIG. 2B, such as a thiourethane group, a urethane group, a urea group, and an imide group.

The multifunctional thiol monomer 206 may be a bifunctional thiol as illustrated in FIG. 2A, having two terminal thiol groups 216. In another approach, the multifunctional thiol monomer may be a tetrafunctional thiol having four terminal thiol groups.

The thiol multifunctional monomer may include a number of repeating units that comprise the backbone of the thiol monomer. The number of repeating units may be tuned according to a predefined thiol monomer desired for the resin. Preferably, the number of repeating units is essentially a number that allows the monomer to remain in the liquid phase. For example, the number of repeating units n may be in a range of 0.3<n<10, depending on the desired length of the thiol multifunctional monomer 206 for determining the mechanical properties of the multimaterial.

In one approach, a thiol multifunctional monomer 206 may have a functional group 218 that is preferably a thiourethane group for hydrogen bonding involved in mechanical properties as well for promoting degradation of the formed material in the presence of a base catalyst. A thiourethane functional group in the thiol monomer provides hydrogen bonding for the increased reactivity and also enables the chemical recycling the resulting multimaterial.

A precursor resin 200 includes an epoxy monomer 208 that may include at least two terminal epoxy groups 222. An epoxy monomer having one epoxy group may not efficiently work with an ene monomer or thiol monomer in the resin. In some approaches, an epoxy monomer may include three epoxy functional groups. In some approaches, an epoxy monomer having more than three epoxy group may be difficult to degrade during a recycling process.

Each monomer may be present in the mixture in equal molar ratio. For example, in one approach, a mixture includes 1 M ene multifunctional monomer, 1 M thiol multifunctional monomer, and 1 M epoxy monomer.

The precursor resin mixture includes a curing agent in an effective amount to provide a desired effect on curing of the precursor resin mixture, as would be determinable by one skilled in the art after reading the present disclosure. Preferably, the curing agent includes a combination of a photoinitiator (radical photoinitiator, e.g., TPO-L, IRGACURE 819, etc.) and a thermal initiator (strong base or nucleophile, e.g., imidazole, triethylamine, 1,1,3,3-Tetramethylguanidine, etc.). In one approach, the mixture may include a stabilizer (e.g., Pyrogallol, TEMPO, etc.). The stabilizer may be included in an effective amount to extend the pot-life of the mixture before polymerization and crosslinking of the monomers. In one example, Pyrogallol, a radical stabilizer for stabilizing the monomers in the mixture. In one exemplary approach, the stabilizer may be present in the mixture in a range from 0.2 wt. % to 1.0 wt. % of the total weight of the mixture.

A photoinitiator may be selected from radical initiators well known in the art for initiating a photopolymerization reaction of monomers during exposure to light. In one approach, a radical initiator may be included in an effective amount to cause partial crosslinking of the monomers in the presence of a stimulus. In another approach, a radical initiator may be included in an effective amount to cause complete polymerization and crosslinking of monomers in the presence of a stimulus. In one exemplary approach, the radical initiator may be present in the mixture in a range from 0.1 wt. % to 1.0 wt. % of the total weight of the mixture. At amounts greater than 1.0 wt. %, the radical initiator may be present in excess and no longer have an effect on the polymerization of the mixture. In one example, a photoinitiator may include TPO-L.

A thermal initiator may be selected from thermal initiators well known in the art for initiating polymerization and crosslinking in the presence of applied heat. In one approach, a thermal initiator may be included in an effective amount to cause partial crosslinking of the monomers in the presence of applied heat as a stimulus. In another approach, a thermal initiator may be included in an effective amount to cause complete polymerization and crosslinking of monomers in the presence of applied heat as a stimulus. In one exemplary approach, the thermal initiator may be present in the mixture in a range from 0.5 wt. % to 2.0 wt. % of the total weight of the mixture. In some approaches, a thermal initiator may include an imidazole-based thermal initiator, for example, such as Curezol, for allowing good latency of the mixture with rapid reaction at elevated temperatures.

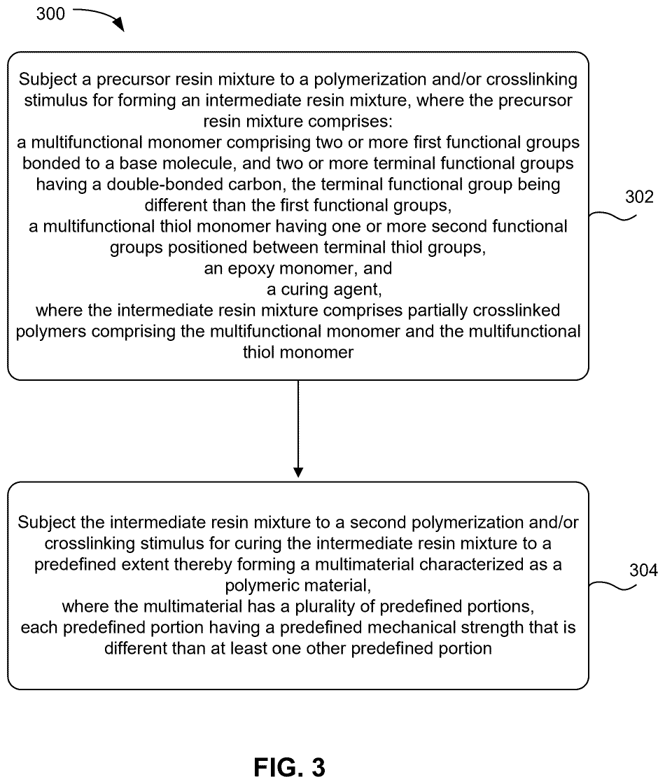

FIG. 3 shows a method 300 for forming a multimaterial being polymeric material having a modulus gradient, in accordance with one aspect of one inventive aspect. As an option, the present method 300 may be implemented to construct structures such as those shown in the other FIGS. described herein. Of course, however, this method 300 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 3 may be included in method 300, according to various embodiments. It should also be noted that any of the aforementioned features may be used in any of the embodiments described in accordance with the various methods.

Operation 302 includes subjecting a precursor resin mixture to a polymerization and/or crosslinking stimulus for forming an intermediate resin mixture. The precursor resin mixture as described herein includes a multifunctional monomer having two or more terminal functional groups having a double-bonded carbon (e.g., an “ene” monomer), and functional groups bonded to a base molecule that form a backbone of the monomer. The precursor resin also include a multifunctional thiol monomer that may have a backbone comprised of functional groups and an epoxy monomer. The precursor resin includes a curing agent.

In various approaches, the polymerization and/or crosslinking stimulus causes the formation of an intermediate resin mixture that includes partially crosslinked polymers formed from the reaction of the multifunctional monomer (the ene monomer) and the multifunctional thiol monomer. An extent of partial crosslinking correlates to a dosage of stimulus that is subjected to the precursor resin mixture.

In one approach, the polymerization and/or crosslinking stimulus may include exposing the precursor resin mixture to a dosage of light to initiate partial crosslinking of the ene multifunctional monomer and the thiol multifunctional monomer. A dosage is generally a function of the intensity of light and duration of exposure. An extent of partial crosslinking, where the intermediate resin mixture is not fully crosslinked, may be predefined according to the desired mechanical toughness for a predefined portion of the multimaterial. For example, exposure of light to a portion of the material for a short period of time (e.g., 150 seconds) causes less crosslinking and in turn the portion has a low mechanical toughness in the final material.

Light-initiated polymerization and/or crosslinking may be determined according to the photoinitiator (e.g., radical initiator) present as a curing agent. For example, a precursor resin mixture that includes TPO-L photoinitiator may be exposure to light at a wavelength of 405 nm. Conditions and techniques of light-initiated polymerization and/or crosslinking generally known in the art may be applied to the precursor resin mixture.

In another approach, the precursor resin may be subjected to heating at a raised temperature for a duration of time to initiate polymerization and/or crosslinking in the presence of a thermal initiator. The raised temperature may be a temperature in a range of about 50° C. to about 100° C. The raised temperature may be determined according to the thermal initiator present in the precursor resin mixture.

Operation 304 includes subjecting the intermediate resin mixture to a second polymerization and/or crosslinking stimulus for curing to a predefined extent thereby forming a multimaterial characterized as a polymer network. The formed multimaterial has a plurality of predefined portions. Each predefined portion has a predefined mechanical strength that may be different than at least one other predefined portion. The formed multimaterial has a modulus gradient.

Preferably, in some approaches, the second polymerization and/or crosslinking stimulus is different than the polymerization and/or crosslinking stimulus used in operation 302. In one approach, the second polymerization and/or crosslinking stimulus may include exposure of the intermediate resin mixture to a dosage of light—in an approach where the precursor resin mixture is subjected to a raised temperature in operation 302. In another approach, the second polymerization and/or crosslinking stimulus may include exposure of the intermediate resin mixture to a second dosage of light using the same light source as the dosage of light applied in operation 302, but having a different dosage (e.g., longer or shorter duration) and/or different intensity (e.g., brightness). In yet another approach, the second polymerization and/or crosslinking stimulus may include exposure of the intermediate resin mixture to a second dosage of light that uses a different light source as the light used in operation 302.

In some approaches, the second polymerization and/or crosslinking stimulus may include raising the temperature of the intermediate resin mixture—in an approach where the precursor resin mixture is exposed to a dosage of light for crosslinking in operation 302. The raised temperature may be a temperature in a range of about 50° C. to about 100° C. The raised temperature may be determined according to the thermal initiator initially present in the precursor resin mixture and present in the intermediate resin mixture. The thermal cure of the material sets the material at the modulus derived from the first light-stimulated cure of the material.

In one approach, the intermediate resin mixture may be heated with a raised temperature in two steps. For example, a first temperature is around 80° C. for 2 hours to finish off the second stage of the curing, and then the temperature is raised to a range of greater than 100° C. to 150° C. for about 20 hours (e.g., overnight).

In preferred approaches, the polymerization and/or crosslinking of the intermediate resin mixture in operation 304 results in complete polymerization and/or crosslinking of the material. A second polymerization and/or crosslinking operation allows a polymeric material (being completely polymerized) to be characterized by predefined portions having a modulus gradient.

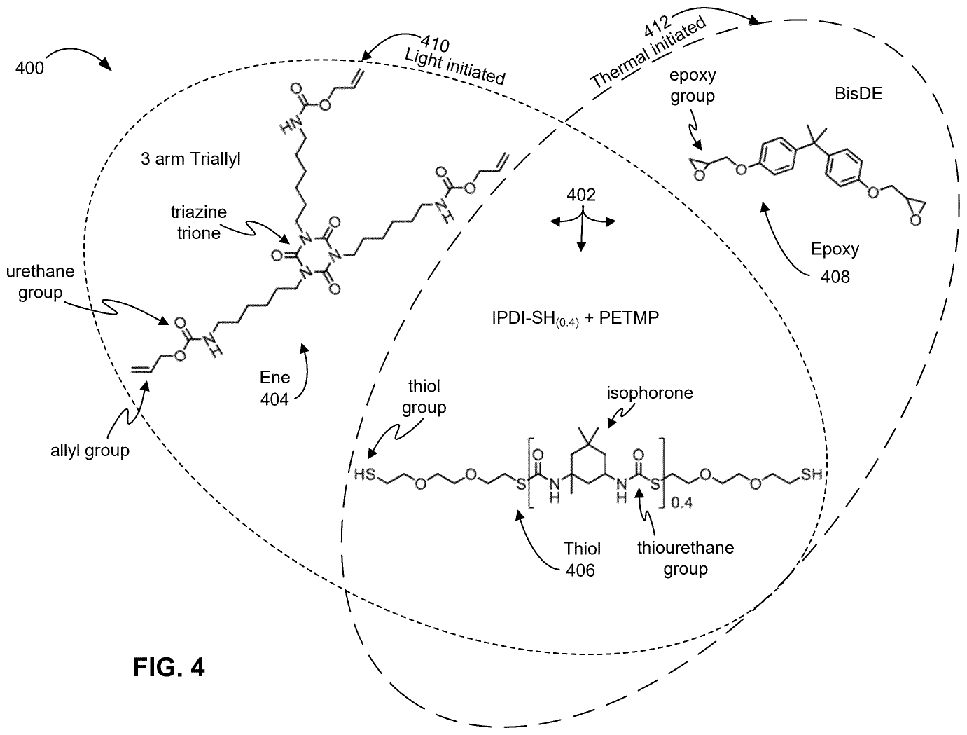

In one example, a process 400 of forming a multimaterial having a modulus gradient is illustrated in FIG. 4. A precursor resin mixture 402 includes a multifunctional ene monomer 404 having a triazine trione base molecule with three bound urethane groups, a multifunctional thiol monomer 406 having a bifunctional thiol, and an epoxy monomer 408 having at least two terminal epoxy groups. The multifunctional ene monomer 404 includes terminal allyl groups on each of the urethane arms of the monomer. The multifunctional thiol monomer 406 has 0.4 repeating units of the IPDI molecule in the thiol monomer. In this example, the multifunctional thiol monomer 406 is shown as an isophorone diisocyante plus a pentaerythritol tetra (3-mercaptopropionate) (IPDI-SH (0.4)+PETMP) monomer. The epoxy monomer 408 is shown as a bisphenol A diglycidyl ether (BisDE).

The precursor resin mixture 402 also includes a photoinitiator, a thermal initiator, and a stabilizer. The first operation 410 of crosslinking the multifunctional ene monomer 404 and the multifunctional thiol monomer 406 is illustrated by the short-dash oval where the precursor resin mixture is exposed to a light of 405 nm to form an intermediate resin mixture. The intermediate resin mixture includes the epoxy monomer 408 and additives initially present in the precursor resin mixture and the light-induced crosslinked multifunctional ene monomer 404 and multifunctional thiol monomer 406.

The second operation 412 includes subjecting the intermediate resin mixture to a raised temperature to induce a thermal-initiated (long-dash oval) crosslinking and/or polymerization of the components of the intermediate resin mixture. The second operation 412 may include two heating steps: the first heating step at a raised temperature of 80° C. for a short period of time to initiate crosslinking between the monomer, and a second heating step at 120° C. for a long duration of time to complete the polymerization of the monomers.

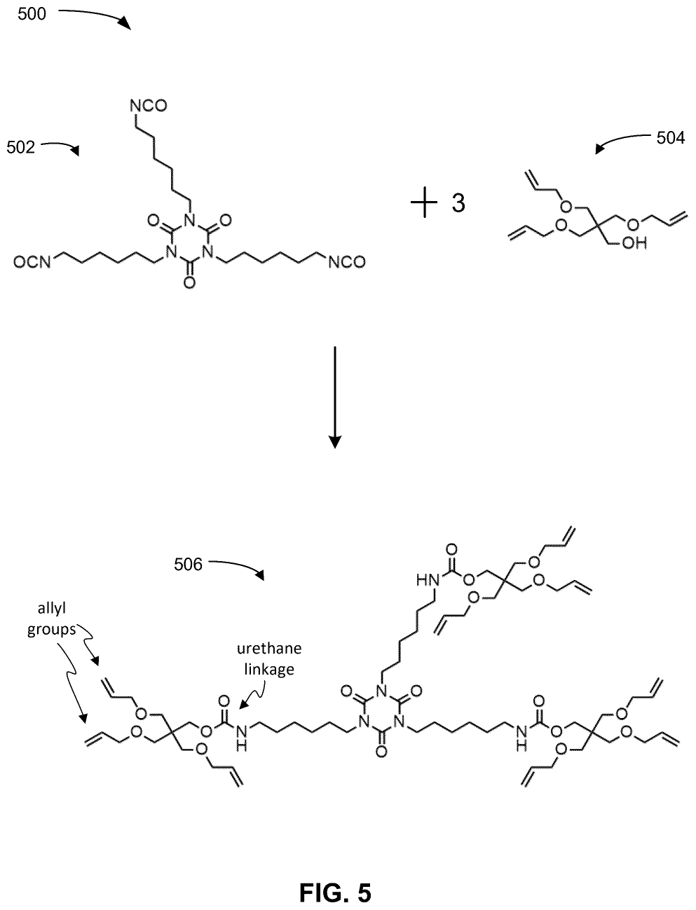

As illustrated in FIG. 4, the multifunctional ene monomer 404 may include three urethane arms with each arm having a terminal allyl group. The multifunctional ene monomer may be engineered to include multiple terminal allyl groups. A process 500 is illustrated in FIG. 5 for forming a multifunctional ene monomer 506 that has nine terminal allyl groups. A multifunctional monomer 502 may be reacted with multiple (e.g., 3) 3-propanediol allyl ether 504 molecules to form a multifunctional ene monomer 506 having three terminal allyl groups on each urethane linkage (i.e., urethane arm) of the molecule thereby forming a multifunctional ene monomer having nine terminal allyl groups. The number of multifunctional groups on a multifunctional ene monomer molecule may include from 3, 6, 9, etc. terminal functional groups having a double-bonded carbon.

According to one embodiment, the precursor resin mixture may be printed using volumetric additive manufacturing techniques. In a preferred approach, a precursor resin having a multifunctional ene monomer with greater than six terminal functional groups having a doubled-bonded carbon provides more efficient gelation of the resin, and thus, allows 3D printing of complex parts. In various approaches, the precursor resin mixture is used to print a complex geometric structure having predefined portions of specific mechanical strength. According to one approach, a grayscale printer is used for printing the resin. In another approach, a two-dimensional volumetric additive manufacturing system is used for printing the resin.

According to one embodiment, through the fusion of these three component monomers, our distinct system offers the capability to finely control mechanical attributes, such as elastic modulus, by adjusting the dosage of UV light throughout the additive manufacturing process. The precursor resin may include an ene monomer including a urethane-based multifunctional allyl compound, a thiol monomer being a thiourethane-based dithiol, and an epoxy monomer being a diepoxy. These components are combined in a stoichiometric ratio in conjunction with photo-crosslinkers and thermal crosslinkers to produce resulting resin.

The resulting multimaterial may have an elastic modulus range of 1.5-500 MPa. At least one of the predefined portions of the multimaterial hs a predefined gradient of mechanical toughness. Leveraging the urethane linkage within the monomer backbone, the disclosed multimaterial system exhibits an impressive toughness spanning a range of 202-2752 MPa/m². In various approaches, the multimaterial may have a predefined portion having a mechanical toughness that is greater than 2000 MPa/m², and a different predefined portion having a mechanical toughness that is in a range of greater than 0 MPa/m² and less than 2000 MPa/m².

According to one embodiment, a multimaterial is a polymeric material comprising a urethane linkages and characterized as having a modulus gradient. The multimaterial includes predefined portions having distinct mechanical toughness: a first predefined portion has a first mechanical toughness and a second predefined portion has a second predefined toughness that is different than the first mechanical toughness.

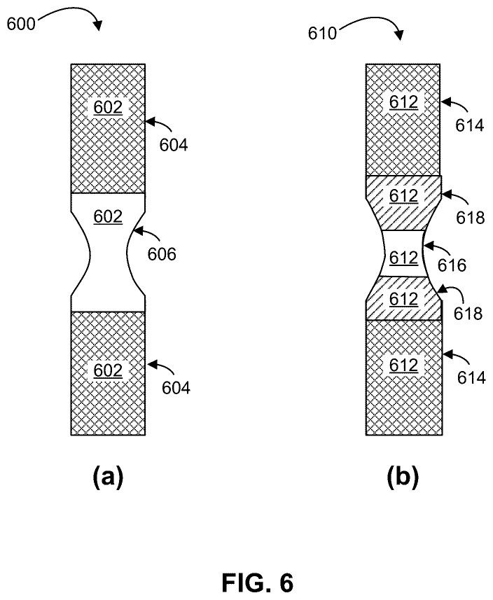

In one example, as illustrated in part (a) of FIG. 6, a multimaterial 600 is a polymeric material 602 having urethane linkages. The multimaterial 600 has predefined portions 604, 606 that are characterized by having distinct mechanical toughness. Each predefined portion 604, 606 is comprised of the polymeric material 602. The difference between the predefined portions 604, 606 is the degree of mechanical toughness of the polymeric material 602. The degree of mechanical toughness is illustrated as patterned portion in the schematic drawings of FIG. 6. A multimaterial 600 has a predefined portions 604 that have a mechanical toughness defined by the duration of light-stimulated crosslinking of the precursor resin (e.g., operation 302 of FIG. 3). Extending the duration (greater than 50 seconds up to 800 seconds or higher) of light-stimulated crosslinking results in increased mechanical toughness of the portion 604 exposed to the light stimulus. The mechanical toughness of the predefined portions 604 may be in a range of greater than 500 MPa/m² (illustrated as cross-hatch pattern). In contrast, the predefined portion 606 may receive no light stimulus and thus the mechanical toughness of the predefined portion 606 may be 0 MPa/m² (illustrated as solid white).

In another example as illustrated in part (b) of FIG. 6, a multimaterial 610 is a polymeric material 612 having urethane linkages. The multimaterial 610 has predefined portions 614, 616, 618 that are characterized by having distinct mechanical toughness. Each predefined portion 614, 616, 618 is comprised of the polymeric material 612. The difference between the predefined portions 614, 616, 618 is the degree of mechanical toughness of the polymeric material 612. A multimaterial 610 has a predefined portions 614 that have a mechanical toughness defined by the duration of light-stimulated crosslinking of the precursor resin (e.g., operation 302 of FIG. 3). In this example, extending the duration (greater than 400 seconds up to 800 seconds or higher) of light-stimulated crosslinking results in increased mechanical toughness of the portion 614 exposed to the light stimulus. The mechanical toughness of the predefined portions 604 may be in a range of greater than 2000 MPa/m² (illustrated as cross-hatch pattern). In contrast, the predefined portion 616 may receive no light stimulus and thus the mechanical toughness of the predefined portion 616 may be 0 MPa/m² (illustrated as solid white). The portion 618 may be a gradient of mechanical toughness resulting from an exposure of light for a duration of time greater than 0 and less than the time of light exposure for portion 616.

These components allow the tunability based on the usage and utilization of the thiol component that can be used in both photo-stimulated and thermal-stimulated crosslinking that dictate mechanical behavior. The resulting thermosets when exposed to various UV dosages are shown in the representative stress strain cures. These show the tuneablity that gives rise to a 333× difference in elastic modulus for the 3-arm triallyl system and 27× difference in the 9-allyl system.

One aspect of the embodiment involves an innovative chemical recycling approach for the enhancement of multimaterials. The incorporation of the urethane bond not only enhance the mechanical properties of the multimaterial but also introduces the concept of polymer network recyclability. These multimaterials can be depolymerized with the introduction of an excess of dithiols at ambient temperature. The reclaimed oligomer can then be reutilized in the design of new multimaterials, showcasing the sustainable potential of this approach.

According to one approach, the polymeric material may be configured to be converted into monomer by-products. The multimaterial comprising the polymeric material may be chemically recycled into monomer by products for use in fabricating other products. A method includes converting the polymeric material to monomer by-products in the presence of a functional thiol and a base catalyst in relative effective functional amounts to cause and/or enhance the conversion. In preferred approaches, converting the polymeric material to monomer by-products does not include added heat.

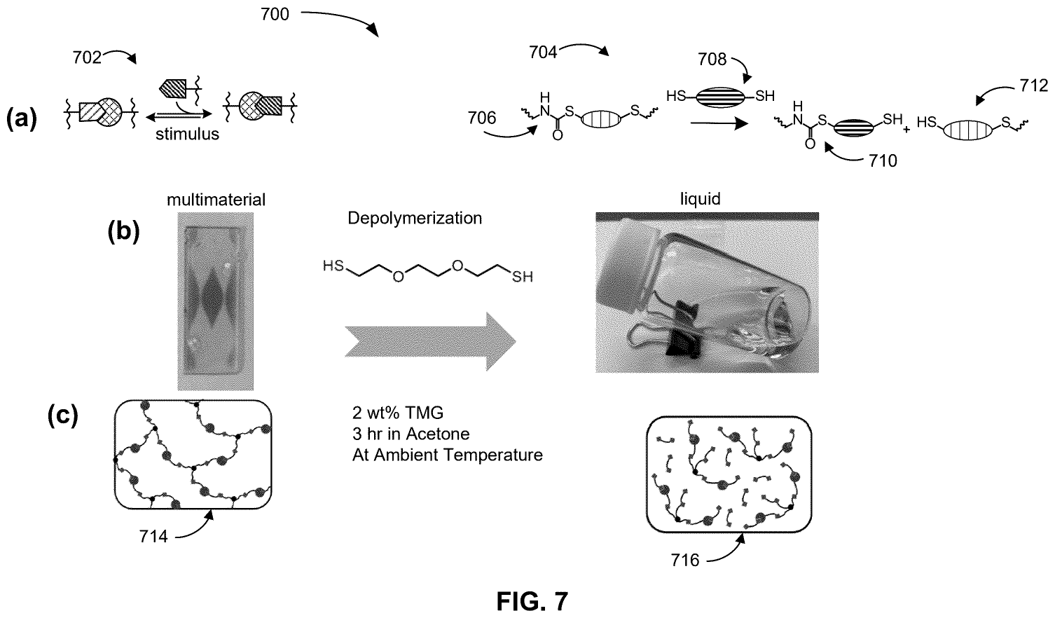

According to one embodiment, a multimaterial having a backbone including urethane bonds, urea bonds, imide bonds, thiourethane bonds, etc. is a chemically recyclable multimaterial. As illustrated in FIG. 7, in one example, as shown in the schematic diagrams of part (a), a reaction pathway 702 of the formation of a multimaterial formed with thiol urethane molecules of a resin stimulated with light and forming thiol urethane bonds. Reaction pathway 704 shows the depolymerization pathway of the multimaterial 706 having thiol urethane bonds. In various approaches, a depolymerization pathway includes adding a functional dithiol and a base catalyst (e.g., 1,1,3,3-Tetramethylguanidine (TMG), 1,8-Diazabicyclo [5.4.0]undec-7-ene, triazabicyclodecene compounds, etc.), each in an effective amount to cause and/or enhance the conversion of the multimaterial into monomer by-products. In preferred approaches, a depolymerization reaction includes greater than 4× by weight of dithiol relative to the polymeric material and a range of 2 wt. % up to 10 wt. % base catalyst. In an exemplary approach, a depolymerization reaction of a polymeric material includes about 4× by weight of dithiol and 2 wt. % base catalyst.

In one example, a functional dithiol 708 is added to the multimaterial 706 at ambient temperature in the presence of a catalyst such as 2 wt. % TMG for 3 hours in acetone. The thiol urethane bonds of the multimaterial 706 is susceptible to depolymerization with additional di-thiol molecule 708 where an exchange reaction breaks the polymeric network to form the monomer by-products 710, 712. In some approaches, a multimaterial formed with urethane bonds may be depolymerized with a functional alcohol, a monothiol, a molecule having a dithiol functional groups (e.g., hexane dithiol, ethylene glycol Bis(3-mercaptopropionate), 1,2-Bis(2-mercaptoethoxy) ethane), etc.

As shown in the images of part (b), the multimaterial in the presence of the TMG catalyst in acetone at ambient conditions becomes a liquid. Part (c) illustrates schematic diagrams of a polymeric network as a multimaterial 714 and after the depolymerization process, the polymeric network is broken into monomer by-products 716 thereby becoming a liquid.

According to one embodiment, a process of converting a multimaterial to monomer by-products uses methodology disclosed in U.S. Provisional Patent Application No. 63/535,220 filed Aug. 29, 2023, which is herein incorporated by reference. According to various approaches, functional alcohol, functional thiol, etc. may be used to depolymerize a polyurethane crosslinked network (e.g., a polymeric material as disclosed herein). In some approaches, a functional alcohol, functional thiol, etc. may be used to depolymerize a polyurea crosslinked network, a polyimide crosslinked network, etc. In one approach, a mixture for converting a polyurethane to useable by-products may include a functional alcohol and a catalyst. The mixture may be added to a polyurethane, where the polyurethane includes at least one urethane linkage. The mixture may be characterized as causing a reaction with the polyurethane upon addition of the mixture to the polyurethane to form a product that includes a diallyl urethane monomer and a multi-functional alcohol.

The process as described herein is able to upcycle polyurethane material into a high yield of products using a functional alcohol, functional thiol, etc. and catalyst at ambient temperatures, ideally without any added heat and without any added pressure. In one approach, using functional alcohols such as allyl alcohol to degrade polyurethane may generate a yield of monomer by-product greater than 70%.

The mixture of monomer by-products may include further processing steps to separate the two by-products from the product mixture before being used applications, e.g., in photopolymerization methods. In sharp contrast, conventional recycling methods typically include continued processing of the degradation products to synthesize a useful product for further use. The conventional method can only reclaim a polyol from the degradation method, but cannot reclaim a by-product for photopolymerization processes.

In one approach, a functional alcohol may depolymerize urethane at ambient temperature followed by a simple purification step to separate the two by-products, the multi-functional alcohol and the urethane “resin” (e.g., diallyl urethan monomer). However, for each by-product, no additional cleaning procedure of the separated by-product may be needed to purify the depolymerized by-products. Moreover, the functional alcohol in a reaction with polyurethane generates a high yield of an end product that is useful for three-dimensional (3D) printing. For example, an allyl alcohol reacts with polyurethane to form a high yield of a diallyl urethane monomer. In various approaches, converting polyurethane material may be useable for upgrading polyurethane (i.e., converting the polyurethane molecules) in to useable end products such as a diallyl urethane monomer and a multi-functional alcohol.

In some approaches, the functional alcohols include allyl alcohol, propargyl alcohol, glycidol, allyl amine, propargylamine, etc. Alcohols such as functional alcohols with photochemical handles, e.g., (hydroxyethyl) methacrylate, (hydroxyethyl) acrylate, etc. tend not to be as efficient as the allyl alcohol because of stability issues of the functional alcohol.

In preferred approaches, the catalyst is a base catalyst. The selection of base catalyst has a strong effect on the reaction yield. According to some approaches, the catalyst includes a strong base. The stronger base allows a higher reaction yield. For example, a high reaction yield may be based on the following order of base catalysts: CsCO₃<K₂CO₃<KOH<NaOH<t-BuOK. The base catalyst may include NaOH, KOH, K₂CO₃, NaCO₃, tert-butoxide (t-BuOK), t-BuONa, etc.

Preferably, the functional alcohol is present in molar excess of the urethane linkages of the polyurethane. In preferred approaches, the functional alcohol includes at least one alcohol (—OH) group. The functional alcohol may be present in an amount where the number of —OH groups is about 10 times greater than the number of urethane linkages of the polyurethane in the reaction mixture.

The amount of a base catalyst may be in a ratio of 0.5 to 1 molar equivalent of a catalyst relative to a molar equivalent of urethane linkages of the polyurethane. Higher concentrations of a stronger base, e.g., NaOH, KOH, etc., may result in a reduced yield of desired end products. Alternatively, less strong bases may be present as a catalyst in a molar excess of the urethane linkages of the polyurethane.

Although adding heat to the reaction may increase the rate of degradation, there is a higher proportion of by-products produced by side-reactions in the reaction mixture. In one approach, heating the reaction mixture to 60° C. to increase the yield of reclaimed polyol using methanol. In an exemplary approach, the reaction mixture is maintained at ambient temperature (i.e., no added heat) and no added pressure and thus produces a high yield of the desired end products of a diallyl urethane monomer and a multi-functional alcohol. The reaction end products are essentially free of by-products produced by undesirable side-reactions.

In one example, components are mixed at room temperature with no added pressure, with a stirrer, polymer degrades overnight, approximately 12 hours. In some approaches, a reaction is essentially complete after 20 hours of stirring at room temperature. In some approaches, the mixture may be stirred at room temperature up to 40 hours to make sure the reaction is complete.

Another facet of various embodiments involves its application as tissue scaffold. The precisely controlled spatial stiffness inherent to these multimaterials renders them exceptionally suitable for serving as an optimal tissue scaffold, particularly for the purpose of bone tissue repair. The present invention concerns photopolymer in general, and particularly concerns resins suitable for stereolithography, two photon lithography, volumetric additive manufacturing, UV-coating, and bioengineering application.

### Experiments

In one example, a resin includes three monomers: 1 M of the alkene monomer 3 arm triallyl, 1 M of a thiol monomer that includes 0.95 M IPDI-SH (0.4)+0.05 M PETMP, and 1 M of an epoxy monomer BisDE. The resin also includes a curing agent such as 0.20 wt. % pyrogallol, 0.5 wt. % TPO-L, and 1.0 wt. % Curezol 1B2MZ (IMCD US, Westlake, OH).

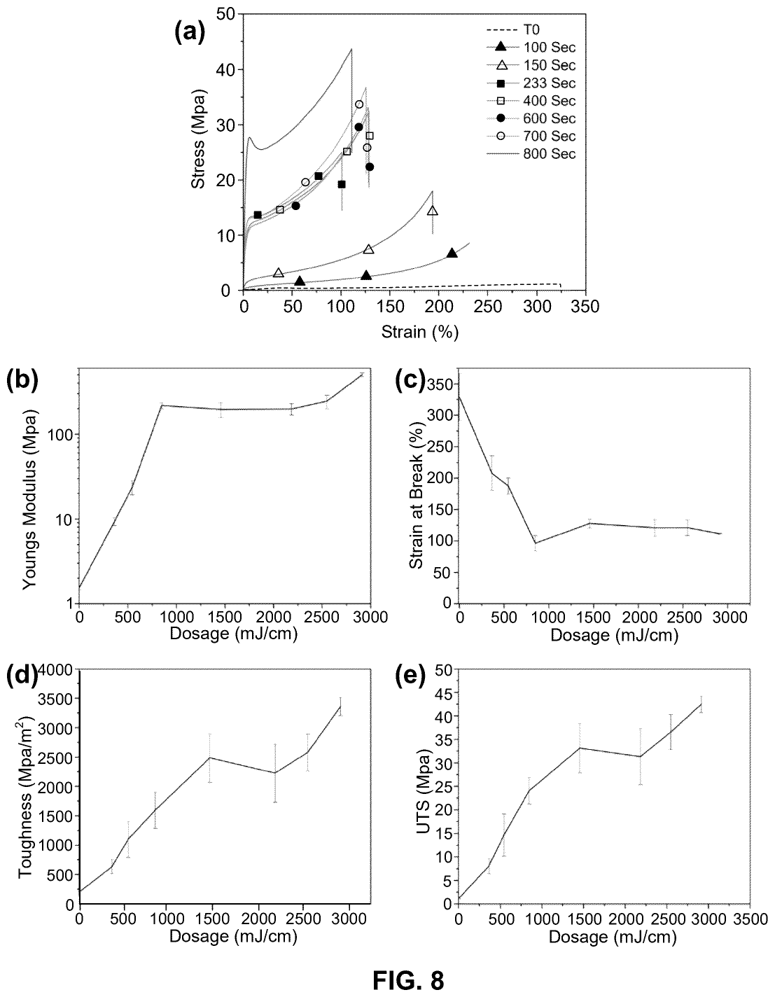

FIG. 8 depicts a series of plots of the UV tuneable mechanical behavior of the multimaterial formed with a precursor resin including a 3-arm triallyl alkene monomer. The curing conditions of the multimaterial include a first curing using light-mediated radiation of 3.64 mW/cm², and a wavelength of 405 nm. A second curing of the material included application of heat at 80° C. for 2 hrs, followed by application of heat at 120° C. for 20 hours. Tensile testing of the material included 5 mm/minute. Part (a) depicts the stress versus strain of the multimaterial formed at different light-mediated curing times. The modulus of the material is tuned according to the length of curing by exposure to light. For instance, 800 second exposure to light forms a stiffer material, a 200 to 700 second exposure to light forms a bit more ductile material, and a 100 to 150 exposure to light forms the most ductile material.

Parts (b) through (e) represent mechanical properties of the multimaterial formed with triallyl alkene monomer in terms of dosage of the light-induced curing (e.g., 100 seconds at 3.64 mW/cm² is a dosage of about 364 mJ/cm). Part (b) shows the Young's modulus of the multimaterial increases with increased light dosage and plateaus at about 100 mJ/cm. Part (c) shows the strain at break decreases remarkably until about 1000 mJ/cm. Part (d) shows the Toughness of the multimaterial with increased dosage, such that increasing the curing dosage strengthens the multimaterial. Toughness is defined as the area under the stress versus the strain curve (i.e., the energy that results in breaking the polymer material). Part (e) is a plot of the ultimate tensile strength (UTS) of the multimaterial with increasing cure dosage.

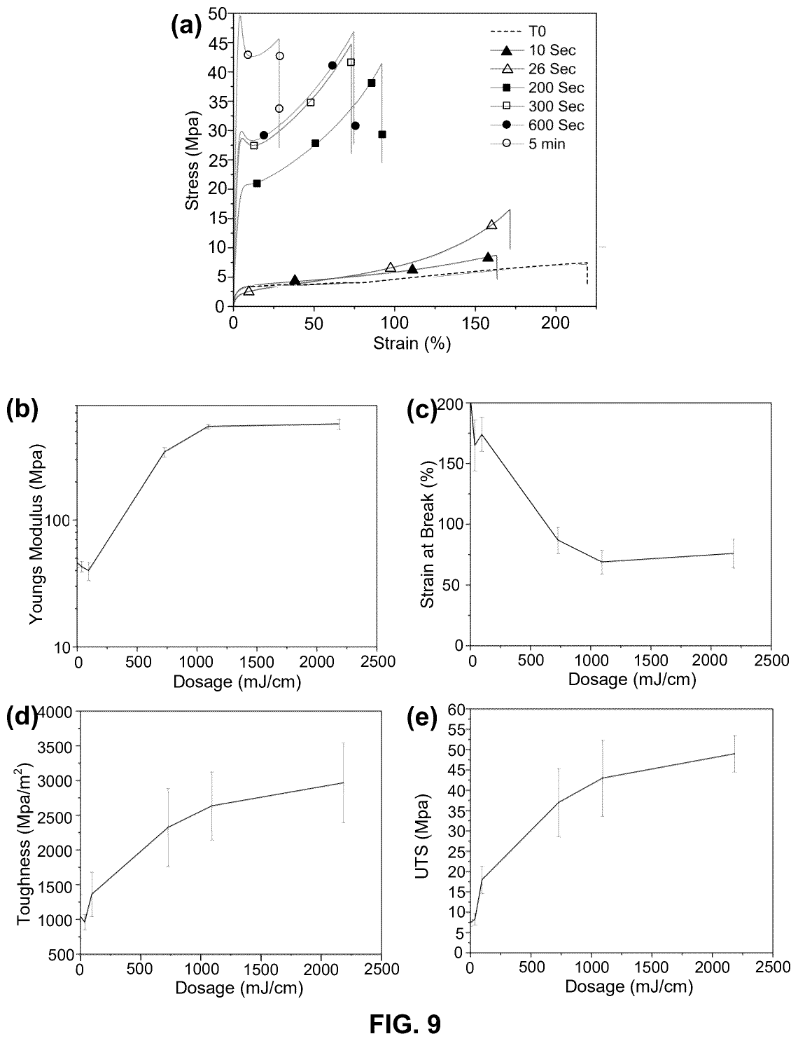

FIG. 9 depicts a series of plots of the UV tuneable mechanical behavior of the multimaterial formed with a precursor resin including a 9-allyl monomer. The curing conditions were the same as the curing conditions for the multimaterial formed with the 3-arm triallyl alkene monomer in FIG. 8. Part (a) depicts the stress versus strain of the 3-arm 9-allyl multimaterial formed at different light-mediated curing times. The modulus of the material is tuned according to the length of curing by exposure to light. The longer times (i.e., greater dosage) of curing generated stiffer multimaterial, with greater stiffness than the multimaterial formed with the 3-arm triallyl alkene shown in FIG. 8.

Parts (b) through (e) represent mechanical properties of the multimaterial formed with 9-allyl alkene monomer in terms of dosage of the light-induced curing. The Young's modulus peaked at a dosage of about 1200 mJ/cm (part (b)), the strain at break was about similar to the multimaterial formed with the 3-arm triallyl alkene monomer (part (c)), the measurement of toughness demonstrated a more steady increase to less than 3000 MPa/m², lower than the multimaterial formed with the 3-arm triallyl alkene (part (d)), and the UTS reached about 40 MPa at a dosage of about 1000 MPa/m² and showed more steady increase thereafter compared to the multimaterial formed with 3-arm triallyl alkene (part (e)).

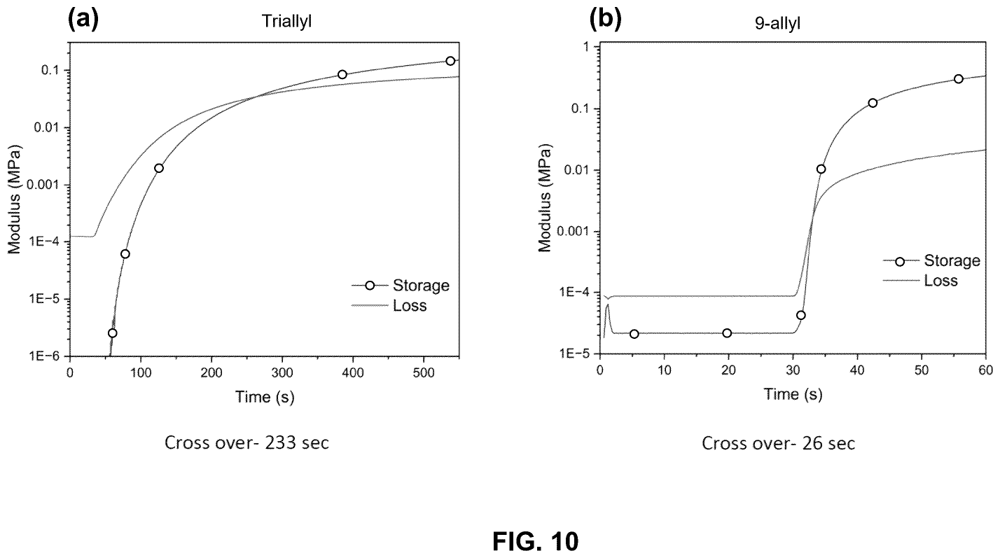

FIG. 10 depicts plots of the photo rheology of the precursor resin mixtures having a 3-arm triallyl alkene monomer (part (a)) and having a 9-allyl alkene monomer (part (b)). The 3-arm allyl precursor mixture demonstrated a longer time to gel such as approximately 233 seconds until crossover of storage modulus and loss modulus (part (a)), and the 9-allyl precursor mixture demonstrated a much shorter time to gel having a crossover of storage modulus and loss modulus at 26 seconds (part (b)). Moreover, the 9-allyl precursor mixture demonstrate behavior similar to a solid.

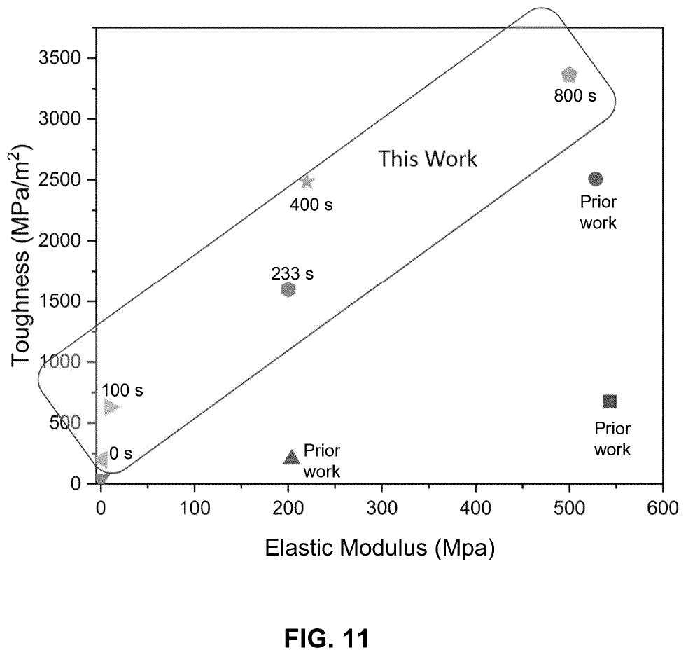

FIG. 11 is a summary plot of the toughness versus elastic modulus of multimaterials formed in prior work compared to the multimaterials formed as described herein (rectangular box). The conventional methods of forming multimaterials have less toughness and higher elastic modulus relative to toughness. In sharp contrast, the multimaterials formed as described herein have greater toughness relative to the elastic modulus of the material. Moreover, the modulus of the material may be tuned by the dosage of the light-induced cure (compare different toughness vs elastic modulus at 100 sec, 233 sec, 400 sec, and 800 sec).

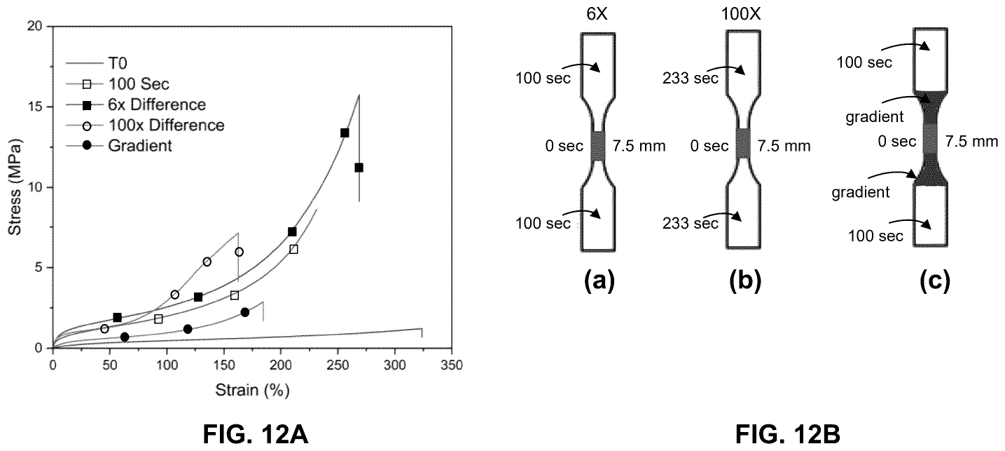

FIG. 12A is a plot of the tensile strength of various regions of the dog-bone structures depicted in FIG. 12B. Part (a) of FIG. 12B is a schematic drawing of a 6X dog-bone structure having a middle section cured for 0 seconds and the ends of the dog-bone structure cured for 100 seconds. The tensile strength testing of the 6X structure is depicted as a the 6X Difference (▪) FIG. 12A. The 6X Difference (▪) withstands significant strain before reacting the ultimate tensile strength.

Part (b) of FIG. 12B is a schematic drawing of a 100X dog-bone structure having a middle section cured for 0 seconds and the ends of the dog-bone structure cured for 233 seconds. The tensile strength testing of the 100X structure is depicted as the 100X Difference (o) which is a stiffer material reaching an ultimate tensile strength lower strain and lower stress as shown in FIG. 12A.

Part (c) of FIG. 12B is a schematic drawing of a dog-bone structure having a middle portion cured for 0 seconds, and then a region on either side of the middle portion that is a gradient material. The remaining portion of each end is cured for 100 seconds. The tensile strength testing of the regions of the dog-bone in part (c) is represented by the gradient (•) region and the 100 sec (□) tensile strength curves of FIG. 12A.

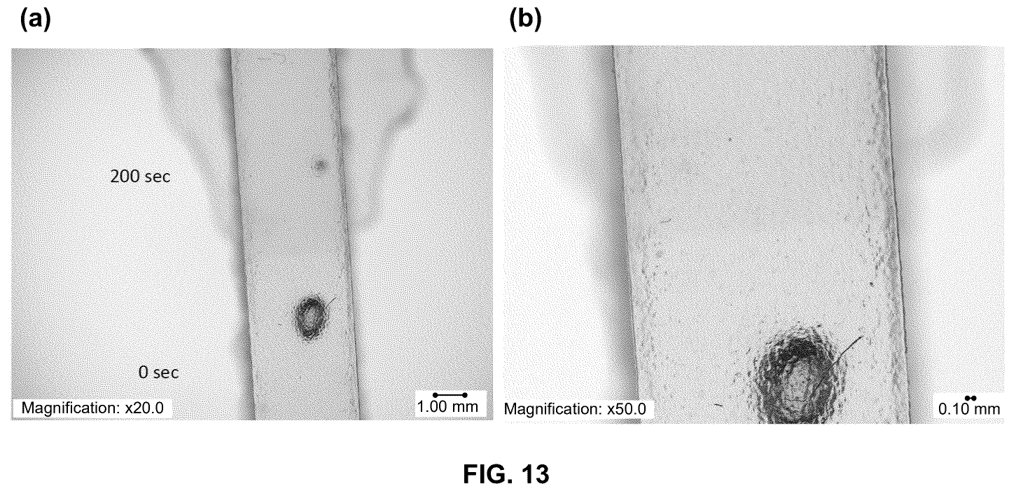

FIG. 13 depicts a structure having different regions of a part having specific mechanical properties. Different magnifications of a multimaterial are shown in the images of part (a) at x20.0 magnification and part (b) at x50.0 magnification. The upper region of the part was cured with light energy for 200 seconds (dark shading) and the lower region (including an oval defect that represents a bubble in the material) was cured with light energy for 0 seconds. The toughness vs. elastic modulus of the upper region is much higher than the lower region that did not receive curing with light energy; both regions are present in the same part. A multimaterial has multiple regions having specific predefined degrees of material strength.

### In Use

Various aspects of the embodiments described herein may be used by additive manufacturing, UV coating, and composites. The material may also be used within the biomedical engineering for tissue engineering.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed is:

1. A precursor resin mixture for forming a multimaterial, the mixture comprising:
a multifunctional monomer comprising two or more first functional groups bonded to a base molecule, and two or more terminal functional groups having a double-bonded carbon, the terminal functional groups being different than the first functional groups;
a multifunctional thiol monomer having one or more second functional groups positioned between terminal thiol groups;
an epoxy monomer; and
a curing agent.

2. The mixture as recited in claim 1, wherein the two or more first functional groups are selected from the group consisting of: a urethane functional group, a urea functional group, and an imide functional group.

3. The mixture as recited in claim 1, wherein the multifunctional monomer comprises at least three urethane first functional groups.

4. The mixture as recited in claim 1, wherein at least one of the two or more terminal functional groups is an allyl group.

5. The mixture as recited in claim 1, wherein at least one of the two or more terminal functional groups is selected from the group consisting of: allyl, allyl ether, vinyl ether, acrylate, methacrylate, propene, norbornene, acrylonitrile, butadiene, methyl crotonate, fumarate, styrene, and maleimide.

6. The mixture as recited in claim 1, wherein the multifunctional monomer comprises at least 6 terminal functional groups having a double-bonded carbon.

7. The mixture as recited in claim 1, wherein the base molecule is selected from the group consisting of: a triazine trione molecule, an aliphatic molecule, and a triphenol molecule.

8. The mixture as recited in claim 1, wherein the multifunctional thiol monomer comprises a tetra-functional thiol.

9. The mixture as recited in claim 1, wherein at least one of the one or more second functional groups is selected from the group consisting of: a thiourethane group, a urethane functional group, a urea functional group, and an imide functional group.

10. The mixture as recited in claim 1, wherein the epoxy monomer comprises at least two terminal epoxy groups.

11. The mixture as recited in claim 1, wherein the curing agent comprises a combination of a photoinitiator and a thermal initiator.

12. The mixture as recited in claim 1, further comprising a stabilizer.

13. A method of forming a multimaterial, the method comprising:
subjecting a precursor resin mixture to a first polymerization and/or crosslinking stimulus for forming an intermediate resin mixture, wherein the precursor resin mixture comprises:
a multifunctional monomer comprising two or more first functional groups bonded to a base molecule, and two or more terminal functional groups having a double-bonded carbon, the terminal functional groups being different than the first functional groups,
a multifunctional thiol monomer having two or more second functional groups positioned between terminal thiol groups,
an epoxy monomer, and
a curing agent,
wherein the intermediate resin mixture comprises partially crosslinked polymers comprising the multifunctional monomer and the multifunctional thiol monomer; and
subjecting the intermediate resin mixture to a second polymerization and/or crosslinking stimulus for curing to a predefined extent thereby forming a multimaterial characterized as a polymeric material,
wherein the multimaterial has a plurality of predefined portions,
each predefined portion having a predefined mechanical strength that is different than at least one other predefined portion.

14. The method as recited in claim 13, wherein the first polymerization and/or crosslinking stimulus is different from the second polymerization and/or crosslinking stimulus, the first polymerization and/or crosslinking stimulus being selected from the group consisting of: a first dosage of light and a raised temperature.

15. The method as recited in claim 14, wherein the second polymerization and/or crosslinking stimulus is selected from the group consisting of: a second dosage of light and a second raised temperature.

16. The method as recited in claim 15, wherein the first and/or second raised temperature includes at least one temperature in a range of about 50 degrees Celsius to about 100 degrees Celsius.

17. The method as recited in claim 13, further comprising converting the polymeric material to monomer by-products in the presence of a functional thiol and a base catalyst.

18. The method as recited in claim 14, wherein the converting the polymeric material to monomer by-products does not include added heat.

19. A multimaterial, comprising:
a polymeric material comprising urethane linkages, wherein the multimaterial is comprised of predefined portions, a first of the predefined portions having a first mechanical toughness and a second of the predefined portions having a second mechanical toughness different than the first mechanical toughness,
wherein the polymeric material is configured to be converted into monomer by-products.

20. The multimaterial as recited in claim 19, wherein the first mechanical toughness is greater than 2000 MPa/m² and the second mechanical toughness is greater than 0 MPa/m² and less than 2000 MPa/m².

21. The multimaterial as recited in claim 19, at least one of the predefined portions has a predefined gradient of mechanical toughness.

22. The multimaterial as recited in claim 19, wherein the multimaterial is configured to undergo the conversion to monomer by-products in the presence of a functional alcohol and a base catalyst.
